(19) United States
(12) Patent Application Publication
(10) Pub. No.: US 2008/0276736 A1
(43) Pub. Date: Nov. 13, 2008

(54) Drive Mechanism Which Can Be Used in a Scanning Device

(75) Inventor: Arnaud Petetin, Saint Georges de Mons (FR)

Correspondence Address: BROWDY AND NEIMARK, P.L.L.C.;624 NINTH STREET, NW, SUITE 300, WASHINGTON, DC, 20001-5303, US

(73) Assignee: Quantel Medical, Clermond Ferrand (FR)

(21) Appl. No.: 11/547,159

(22) PCT Filed: Mar. 17, 2005
(86) PCT No.: PCT/FR2005/000677

§ 371 Date: Oct. 2, 2006

(30) Foreign Application Priority Data
Apr. 1, 2004 (FR) 0403523

(51) Int. Cl. F16H 21/00

(52) U.S. Cl. 74/25

(57) ABSTRACT

The invention relates to a drive mechanism which can be used in a scanning device. The inventive mechanism comprises a device which converts a rotary motion produced by a motor member into a linear reciprocating motion. According to the invention, the aforementioned converter uses: a planetary rotating table (10) which is rotated by the output shaft (9) of the motor member (8), a planet pinion (15) which is pivot mounted to the table (10) and which meshes with a ring gear with a serrated bore (14) that is coaxial to the shaft (9) and solidly connected to the body of the motor member (8), and a drive member (19) which is borne by a support (18) that is solidly connected to the pinion (15). The mechanism can be used in the scanner of an ultrasound probe.

The present invention relates to a drive mechanism which can be used in a scanning device.

It is notably applied, but not exclusively, to the making of an echographic probe involving a mobile transducer element along a predetermined path for example a rectilinear or even arciform path with a fixed or variable curvature. A sectorial movement is also possible.

It is known that in many fields of application, one is led to use echographic probes having increasingly reduced dimensions, these probes involving necessarily a transducer mounted on a more or less complex mechanism most often driven by an electric gear motor. These probes most often have a tubular body, with a substantially cylindrical shape, the interior diameter of which substantially corresponds to the diameter of the gear motor. The drive mechanism of the transducer must then fit into a cylindrical volume, the diameter of which is as close as possible to or even smaller than that of the motor. Because of the miniaturization of motors and requirements imposed by the mode of application of the probe, the space dedicated to these mechanisms becomes increasingly small. Now, these mechanisms often have relatively complex kinematics. Their making then becomes more difficult, or even problematic.

Moreover, the accuracy level required by these mechanisms as well as by the sensors which are associated with them for control purposes is usually very high. Here also, reduction of the available space tends to increase the difficulty encountered for achieving such accuracy levels.

Thus, for example, these mechanisms generally involve kinematics with which the rotary movement of the motor may be converted into an alternating rectilinear movement which may be used for driving the transducer element. Nevertheless, most of these devices such as for example the rod/crank system, have relatively significant bulkiness and are therefore unsuitable in the case when the rectilinear movement needs to be made in a radial plane of the probe.

Moreover, miniaturization of the systems provides increasingly less space to the articulation elements, such as bearings or roll bearings, used in such systems.

More particularly the object of the invention is therefore to suppress these drawbacks.

For this purpose, it proposes a drive mechanism involving a planetary rotating platform driven into rotation by the output shaft of a motorization unit, a satellite pinion pivotally mounted on the platform and which meshes with a ring gear with a serrated bore, coaxial with said shaft and integral with the body of the motor and an axial drive member borne by a support integral with the pinion, the diameter of the pinion being equal to the half of the diameter of the bore of the ring gear and the drive member being positioned so that, during the rotation of the platform, said member makes a rectilinear trajectory connecting two diametrically opposite points of the ring gear.

By these arrangements, a drive mechanism is obtained, which occupies a flat cylindrical space coaxial with the motor and substantially of the same diameter. The motion of the drive member of the sinusoidal type is obtained with minimum friction, low wear and highly reduced play.

It is seen that this mechanism lends itself quite well to a servocontrol system.

Advantageously, if this mechanism is used in a probe for displacing the transducer element along a linear path, the drive member may be coupled with a supporting part of the transducer; this supporting part may be slidably mounted along a slide integral with the body of the probe. This coupling may be achieved either with direct engagement, or with remote engagement, for example by means of magnetic coupling.

Also, this mechanism may be integrated into a more complex drive train with which an alternating rectilinear movement may for example be converted into an arciform movement.

With the present invention, on the basis of the scanning mechanism shown above and described hereafter, any movement may be obtained by adding a scanning stage, for example for simply guiding a piezoelectric element, while being set under the best possible conditions for obtaining an image.

Embodiments of the invention will be described hereafter, as non-limiting examples, with reference to the appended drawings wherein:

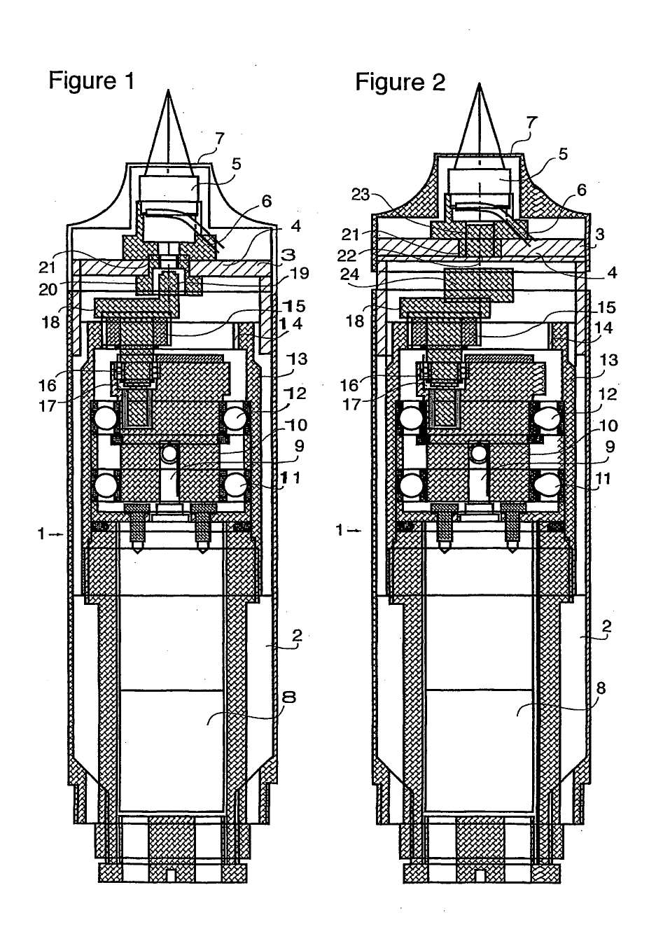

FIGS. 1 and 2 are axial sectional views of two alternative embodiments of an echographic probe with linear motion;

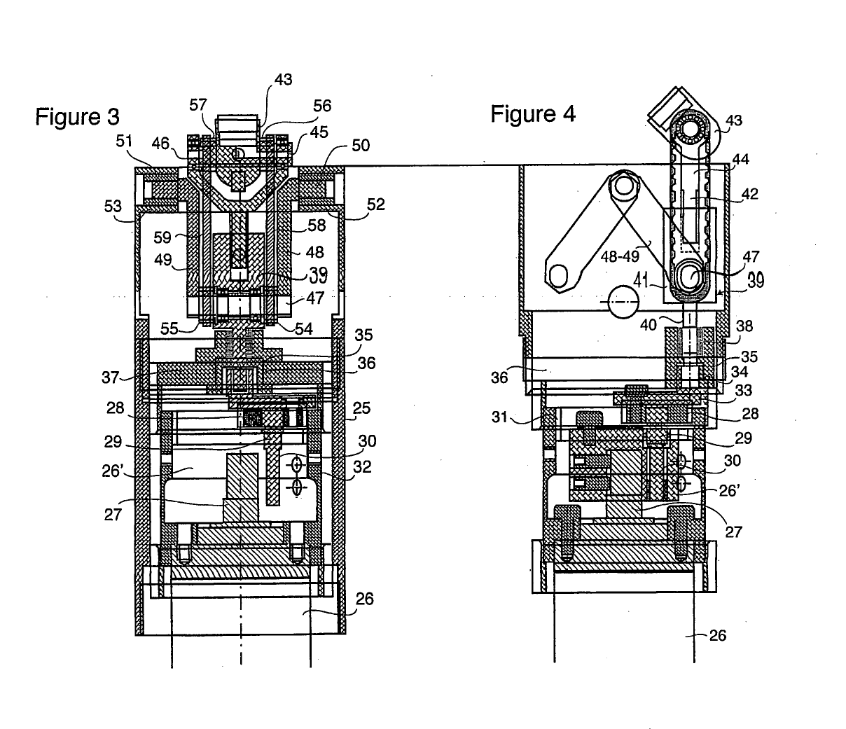

FIGS. 3. and 4 are axial sectional views at 90° from each other of an echographic probe with an arciform motion.

In the examples illustrated in FIGS. 1 and 2, the probe comprises a tubular body 1 divided into two compartments 2, 3 by a transverse partition 4. The front compartment 3 houses a transducer element 5 mounted on a translationally mobile supporting part 6 on the partition 4. This transducer 5 is designed so as to emit focused ultrasonic radiation through the front wall 7 of the probe.

In the example illustrated in FIG. 2, this front compartment 3 is sealed and may be filled with a liquid providing good transmission of ultrasonic waves.

The rear compartment 2 contains a gear motor as well as a mechanism for converting the rotary movement of the output shaft 9 of this motor 8 into an alternating rectilinear movement.

This mechanism involves a cylindrical drive part 10 rotatably mounted coaxially with the output shaft 9 of the motor 8 via two axially shifted bearings (or ball bearings) 11, 12 borne by a tubular sleeve 13 integral with the body of the motor 8.

This tubular sleeve 13 comprises at its front end, internal teeth (ring gear 14) onto which meshes a satellite pinion 15 pivotally mounted on the drive part 10 by means of a shaft 16 which engages into a cylindrical bore 17 of the drive part 10, centered parallel to the axis 9 of motor 8, at a predetermined distance from the latter. The rotary mounting of the shaft 16 in the bore 17 is provided by means of a bearing (or a ball bearing) provided between said shaft 16 and the wall of said bore 17.

The pinion 15 bears via its upper face a supporting part 18 of a member for driving the supporting part 6 of the transducer element 5.

In the example illustrated in FIG. 1, the drive member consists of an axial spindle 19 which engages into the cavity of a slide 20 mobile along a slot 21 provided in the partition 4 and is attached to the supporting part 6.

Thus, during the rotation of the motor 8, the pinion 15 borne by the drive part 18 rotates along a coaxial circular path. Along this path, it meshes onto the teeth 14 of the tubular sleeve 13 by rotating on itself around an axis parallel to the shaft 9 of the motor 8.

The movement of the spindle 19 which corresponds to the product of the dual rotation (planetary/satellite) is an alternating rectilinear movement. The partition 4 is arranged so that the path of the spindle follows the path of the slot 21 and thus the transducer element itself effects a rectilinear alternating movement.

Advantageously, the cavity of the slide 20 intended to receive the spindle 19 will be oblong so as to tolerate differences in alignment.

In the example illustrated in FIG. 2, the partition 4 comprises instead of a slot, a groove 21 closed by a bottom 22. The supporting part 6 has a T shape, the vertical branch of which engages and is guided into the groove 21. This vertical branch, the width of which corresponds to that of the groove 21, comprises a central cavity housing a first permanent magnet 23.

The drive member here consists in a second permanent magnet 24 with inverted polarity relatively to the first one, attached on the upper face of the supporting part 18. This magnet 24 is therefore mobile along a rectilinear path parallel and close to the partition 4.

Magnetic coupling of both permanent magnets 23, 24 and contactless driving of the magnet 23 by the magnet 24 along the groove 21 are thereby obtained.

Of course, the invention is not limited to a particular shape of displacement.

Thus, the mechanism according to the invention may be used for driving rectilinear movement/arciform movement conversion kinematics.

FIGS. 3 and 4 illustrate an embodiment of such an application.

These figures illustrate an eye echography probe with an arciform movement using a drive mechanism with a rectilinear movement similar to the one used in the probe illustrated in FIGS. 1 and 2.

It is recalled that this type of probe has the particularity of taking into account the fact that the cornea is not fully spherical but has significant variations between its centre and the periphery: In fact, the base plane of the cornea has an elliptical shape with a major diameter D of the order of 12 mm and a minor diameter of the order of 11 mm, the diameter difference resulting from the opening and the closing of the eye lids.

Moreover, it is recognized that the cornea has two areas, a central area which is spherical and a peripheral area in which the bending radius gradually increases towards the limb. It therefore appears that the cornea is an aspherical and asymmetrical cap which is gradually flattened towards the periphery. Because of the different bending radii of between the cornea and the sclera, the junction of the cornea and of the sclera has an apparent sulcus at the iridocorneal angle.

The advantage of arciform scanning is to allow the probe to follow a trajectory, the bending radius of which is fixed and substantially equal to the average bending radius of the cornea, while maintaining the axis of the ultrasonic beam orthogonal to a major part of the surface of the cornea and/or the retina, in order to improve the quality of the echographic signal received by the probe while avoiding that the latter approaches the sclera with the risk of hitting it.

The goal of the probe illustrated in FIGS. 3 and 4 is therefore to attain these results, by means of a mechanism with which the dimensions of the probe may be considerably reduced while retaining high accuracy and performance levels.

This probe comprises a tubular supporting structure 25 containing in its lower portion a motor 26 the output shaft of which 27 drives a cylindrical part 26′ on which a pinion 28 is rotatably mounted by means of an axis 29 which engages into a guide consisting of a bearing and of ball bearings mounted in a bore 30 provided in the front face of the cylindrical part, parallel to the axis of the shaft 27 and at a predetermined distance from the latter.

This pinion 28 meshes with the teeth of a ring gear 31 borne by a tubular sleeve 32 integral with the body of the motor 26. It supports here a drive part 33 provided with an axial drive finger 34, which during rotation of the motor 26, makes a rectilinear displacement along one diameter of the tubular sleeve 32.

This finger 34 engages into the rear element of a tubular slide 35 passing through a slot 36 provided in a transverse partition 37 integral with the tubular sleeve 32.

This slide 35 is made by assembling two shouldered front/rear tubular elements, the shoulders of which will return onto the partition 37. This slide may therefore move along the slot 36 while being axially retained in both directions by the shoulders.

The finger 34 comprises a coaxial bore which extends in the extension of a bore 38 of the front element of the slide 35 SO as to form with it a cylindrical bearing.

A cylindrical supporting part 39 is slideably mounted axially in this bearing; the part's lower portion 40 engages into the cylindrical bearing and its other portion 41 of larger diameter is used as a support for an arm 42 bearing the transducer element 43 of the probe on the one hand, and as a joint for a connecting rod assembly.

More specifically, the upper portion of the part 39 comprises a coaxial bore into which a rod, the front fork-shaped end of which forms an articulation yoke 44, engages and is fixed by a key. This yoke 44 comprises two transverse coaxial bores in which two coaxial pins 45, 46 integral with the transducer element 43 are mounted on ball bearings.

Moreover, the part 39 comprises a transverse bore in which a transverse axis 47 is pivotally mounted on ball bearings; both ends of the axis protruding from the part, are respectively integral with the ends of two parallel longitudinal connecting rods 48, 49 forming the aforesaid connecting rod assembly.

The ends of these two connecting rods 48, 49, opposite to the axis 47, are provided with two coaxial respective pins 50, 51 centered parallel to the axis 47, which engage and are pivotally mounted in two respective bearings located in an axial plane perpendicular to the slot. These bearings are positioned in housings 52, 53 provided in the tubular structure 25 in the vicinity of its front aperture.

The ends of the axis 47 emerging from the part 39 include two respective notched pulleys 54, 55 located at right angles to two corresponding pulleys 56, 57 provided on the pins 45, 46 of the transducer element 43.

The pairs of facing pulleys are connected via two respective toothed belts 58, 59.

By these arrangements, when the motor 26 is actuated, the finger 34 makes an alternating linear displacement along the groove 36 in the indicated way, in view of FIG. 1.

During this displacement, it generates translational displacement of the slide 35 and pivoting of both connecting rods 48, 49 around the axis of the pins 50, 51. The part 39 which is driven into translation by the slide under the effect of the circular displacement of the axis 47 effects an axial displacement by sliding in the bearing of the bore 38.

Accordingly, the axis of the pins 45, 46 describes an arciform path which is the product of the translational displacement generated by the slide 35 and of the axial displacement generated by the connecting rods 48, 49.

During this displacement, by the action of the toothed belts 58, 59, the orientation of the transducer element 43 varies according to the orientation of the connecting rods 48, 49 and therefore to the position of the slide 35, the nature of this variation depending on the ratio of the diameters of the notched pulleys 54-55 and 56-57.

This result is notably due to the fact that the means for driving into rotation the transducer element 43 according to the angular position of at least one of the connecting rods (48-49) involves at least:
a first pulley (54, 55) integral with the connecting rod (48, 49) and mounted coaxially with the pivot axis of the connecting rod (48, 49) on the supporting part (39),
a second pulley (56, 57) integral with the transducer element and mounted coaxially with the pivot axis of the transducer element on the supporting part (39),
a drive belt (58, 59) passing over both pulleys (55, 57-54, 56).

In fact, in the example illustrated in FIGS. 3 and 4, the drive mechanism comprises:

two parallel connecting rods (48, 49) pivotally mounted through one of their ends on a structure (25) integral with the body of the motor in two diametrically opposite locations and through their other ends on the aforesaid supporting part (39) around a common transverse axis (47),

two primary pulleys (54, 55) integral with said connecting rods (48, 49) respectively, and mounted coaxially with said common transverse axis (47),

two secondary pulleys (56, 57) integral with said transducer element and mounted coaxially with the pivot axis of the transducer element, both of these secondary pulleys (56, 57) forming with both primary pulleys (54, 55) two facing pairs of pulleys (55, 57-54, 56) and two drive belts (58, 59) passing around both facing pairs of pulleys (55, 57-54, 56), respectively.

Upon examining FIGS. 3 and 4 it clearly appears that an important advantage of the solution described earlier results from its compactness and its miniaturizability.

Of course, the invention is not limited to the embodiment described earlier. Thus, for example, if in a particular embodiment, the transducer is fixed on the axis of rotation 50-51, the obtained movement will be of the sectorial type, the angle of which will depend on the length of the connecting rods 48-49.

1. A drive mechanism which can be used in a scanning device, comprising a device for converting a rotary movement generated by a motor member into an alternating rectilinear movement, this conversion device involving a planetary rotating member driven into rotation by the output shaft of the motor member, a satellite pinion pivotally mounted on the planetary member and meshing with a ring gear with a serrated bore coaxial with said shaft and a member for driving a transducer element borne by a support integral with the pinion, wherein:
the ring gear is borne by a tubular sleeve integral with the body of the motor,
the drive member comprises magnetic coupling means acting on corresponding means providing the driving of the transducer,
the transducer element and the drive member are positioned in two compartments separated by a sealed partition through which the coupling is effected.

2. The drive mechanism according to claim 1, wherein the diameter of the pinion is equal to the half of the diameter of the serrated bore and the drive member is positioned so that, during the rotation of the planetary member, said member makes a rectilinear trajectory connecting two diametrically opposite points of the ring gear.

3. The drive mechanism according to claim 1, used for displacing a transducer element along a linear path, wherein the drive member is coupled with a supporting part of the transducer guided along a linear path.

4. The drive mechanism according to claim 3, wherein the coupling between the supporting part and the drive member is effected with direct meshing by a coupling means such as a drive finger or without any contact by a coupling means such as magnetic means.

5. The drive mechanism according to any of the preceding claims, wherein the planetary member consists in a cylindrical drive part rotatably mounted coaxially with the output shaft of the motor via at least one bearing borne by the tubular sleeve integral with the body of the motor, this tubular sleeve including internal teeth forming the aforesaid ring gear.

6. The drive mechanism according to claim 1, wherein the aforesaid drive member is coupled with rectilinear movement/arciform movement conversion means.

7. The drive mechanism according to claim 6, wherein the aforesaid conversion means involve:
a slide displaced by the drive member so as to make a linear path in a plane perpendicular to the axis of the motor,
a supporting part centered parallel to said axis and slidably mounted axially on the slide, and
at least one connecting rod, one end of which is pivotally mounted on a structure integral with the body of the motor around an axis of rotation located in an axial plane perpendicular to the path of the slide and the other end of which is pivotally mounted on the supporting part,
the arciform displacement of a point of the supporting part resulting from the product of its sliding under the action of the connecting rod and of its translation generated by the slide.

8. The drive mechanism according to claim 7, used in a scanning device of a probe comprising a transducer element borne by a supporting part mobile along an arciform path, wherein said transducer element according to the angular position of the aforesaid connecting rod.

9. The drive mechanism according to claim 8, wherein the aforesaid drive means involves at least:
a first pulley integral with the connecting rod and mounted coaxially with the pivot axis of the connecting rod on the supporting part,
a second pulley integral with the transducer element and mounted coaxially with the pivot axis of the transducer element on the supporting part,
a drive belt passing over both pulleys.

10. The drive mechanism according to claim 6 comprising:
two parallel connecting rods pivotally mounted through one of their ends on a structure integral with the body of the motor in two diametrically opposite locations and through their other ends on the aforesaid supporting part around a common transverse axis,
two primary pulleys integral with said connecting rods respectively, and mounted coaxially with said common transverse axis,
two secondary pulleys integral with said transducer element and mounted coaxially with the pivot axis of the transducer element, both of these secondary pulleys forming with both primary pulleys two facing pairs of pulleys and two drive belts passing around both facing pairs of pulleys, respectively.
